(19) United States
(12) Patent Application Publication
(10) Pub. No.: US 2021/0355619 A1
(43) Pub. Date: Nov. 18, 2021

(54) Carpet Products And Methods Of Manufacturing Same

(71) Applicant: COLUMBIA INSURANCE COMPANY, Omaha, NE (US)

(72) Inventors: William Mark Dothard, Cartersville, GA (US); Pamela Managan Rainey, Cartersville, GA (US)

(21) Appl. No.: 17/388,579

(22) Filed: Jul. 29, 2021

Related U.S. Application Data
(63) Continuation of application No. 14/216,593, filed on Mar. 17, 2014.
(60) Provisional application No. 61/794,873, filed on Mar. 15, 2013.

(51) Int. Cl. D05C 15/26; D06C 23/00; D06C 13/00; D06N 7/00; B32B 5/26; D05C 17/02; D05C 15/32; D05C 15/34

(52) U.S. Cl. CPC D05C 15/26; D06C 23/00; D06C 13/00; D06N 7/0065; D06N 7/0068; B32B 5/26; D06N 2209/0807; D05C 15/32; D05C 15/34; D05C 17/026; Y10T 428/23929; B32B 2471/02; D06N 2209/083; D05C 17/02

(57) ABSTRACT

A deconstructed tufted carpet having an at least partially visible primary backing. In aspects, deconstructed carpet can utilize the primary backing layer as a design element of the overall pattern and styling in order to reduce material use, waste and the ounce weight of the finished carpet and to improve the method of carpet construction. In order to expose the primary backing, at least some yarn can be pulled very low in the pattern areas to expose the primary backing layer. It is contemplated that the primary backing layer can have a color that comprises part of the overall pattern and styling of the carpet.

### CROSS REFERENCE TO RELATED APPLICATION

This application is a continuation of U.S. patent application Ser. No. 14/216,593, filed Mar. 17, 2014, which claims the benefit of the filing date of U.S. Provisional Application No. 61/794,873, filed Mar. 15, 2013. Each of these applications is hereby incorporated herein by reference in its entirety.

### FIELD

Aspects described herein relate generally to carpet designs having an at least partially exposed primary backing layer incorporated into the carpet design and methods for manufacturing the same.

### BACKGROUND

As illustrated in FIG. 1, tufted carpets generally are composite structures which include yarn (which is also known as a fiber bundle), a primary backing material having a face surface and a back surface, an adhesive backing material and, optionally, a secondary backing material. To form the face surface of tufted carpet, yarn can be tufted through the primary backing material such that the longer length of each stitch extends through the face surface of the primary backing material. Typically, the primary backing material can be made of a woven or non-woven material such as a thermoplastic polymer, most commonly polypropylene.

The face of a tufted carpet can generally be made in three ways. First, for loop pile carpet, the yarn loops formed in the tufting process can be left intact. Second, for cut pile carpet, the yarn loops can be cut, either during tufting or after, to produce a pile of single yarn ends instead of loops. Third, some carpet styles can include both loop and cut pile. One variety of this hybrid is referred to as tip-sheared carpet where loops of differing lengths can be tufted followed by shearing the carpet at a height so as to produce a mix of uncut, partially cut, and completely cut loops. Alternatively, the tufting machine can be configured so as to cut only some of the loops, thereby leaving a pattern of cut and uncut loops. Whether loop, cut, or a hybrid, the yarn on the back side of the primary backing material can comprise tight, unextended loops.

The combination of tufted yarn and a primary backing material without the application of an adhesive backing material or secondary backing material is referred to in the carpet industry as raw tufted carpet or greige goods. Greige goods can become finished tufted carpet with the application of an adhesive backing material and an optional secondary backing material to the back side of the primary backing material. Finished tufted carpet can be prepared as broad-loomed carpet in rolls typically 6 or 12 feet wide. Alternatively, carpet can be prepared as carpet tiles in varying shapes and sizes.

A substantial demand exists for tufted carpet designs and methods of manufacture that reduce the waste produced over conventional tufted carpet manufacturing methods that, makes more efficient use of materials and that results in a lighter weight carpet.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

The present invention is generally directed to a deconstructed tufted carpet in which at least a portion of the primary backing is visible or at least partially visible. In aspects, deconstructed carpet can utilize the primary backing layer as a design element of the overall pattern and styling in order to reduce material use, waste and the ounce weight of the finished carpet and to improve the method of carpet construction. In one embodiment, in order to expose the primary backing, at least some yarn is pulled very low in the desired exposed member pattern areas thereby exposing a desired amount of the primary backing layer. It is contemplated that the primary backing layer can have a color that comprises part of the overall pattern and styling of the carpet.

Additional features and advantages of exemplary aspects of the disclosure will be set forth in the description which follows, and in part will be obvious from the description, or may be learned by the practice of such exemplary aspects. The features and advantages of such aspects may be realized and obtained by means of the instruments and combinations particularly pointed out in the appended claims. These and other features will become more fully apparent from the following description and appended claims, or may be learned by the practice of such exemplary aspects as set forth hereinafter.

### BRIEF DESCRIPTION OF THE DRAWINGS

The accompanying drawings, which are incorporated in and constitute a part of this specification, illustrate several aspects described below and together with the description, serve to explain the principles of the invention. Like numbers represent the same elements throughout the figures. The patent or application file contains at least one drawing executed in color. Copies of this patent or patent application publication with color drawing(s) will be provided by the Office upon request and the payment of the necessary fee.

FIG. 1 illustrates one aspect of a deconstructed carpet;

FIG. 2 shows an enlarged plan view of the deconstructed carpet of FIG. 1.

FIG. 3 shows an enlarged plan view of the deconstructed carpet of FIG. 2.

### DETAILED DESCRIPTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a needle bar” can include two or more such needle bars unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used throughout, the term “carpet tile” refers to carpet tiles and other conventional textile-face modular flooring tiles.

As used herein, the definition of the term “color” is referenced in terms of the CIELAB color scale, which was created by the International Commission on Illumination (CIE). The CIELAB color scale provides a uniform scale for measuring and comparing the color values of different samples, Three different color measurements are used to determine the CIELAB color value of a given sample: 1) a white-black color measurement; 2) a red-green color measurement; and 3) a yellow-blue color measurement. The white-black color measurement represents the amount of white present in the sample relative to the amount of black present in the sample. The red-green color measurement represents the amount of red present in the sample relative to the amount of green present in the sample. The yellow-blue color measurement represents the amount of yellow present in the sample relative to the amount of blue present in the sample. CIELAB color scale values can be obtained using color measurement instruments known in the art, including, for example, HunterLab color measurement instruments.

As used throughout, the terms “tuft”, “tufting”, “tufted”, “tufted-in”, and other verb tenses thereof refer to inserting, pressing, passing, and/or any other conventional process by which yarn is attached or otherwise coupled to the carpet backing.

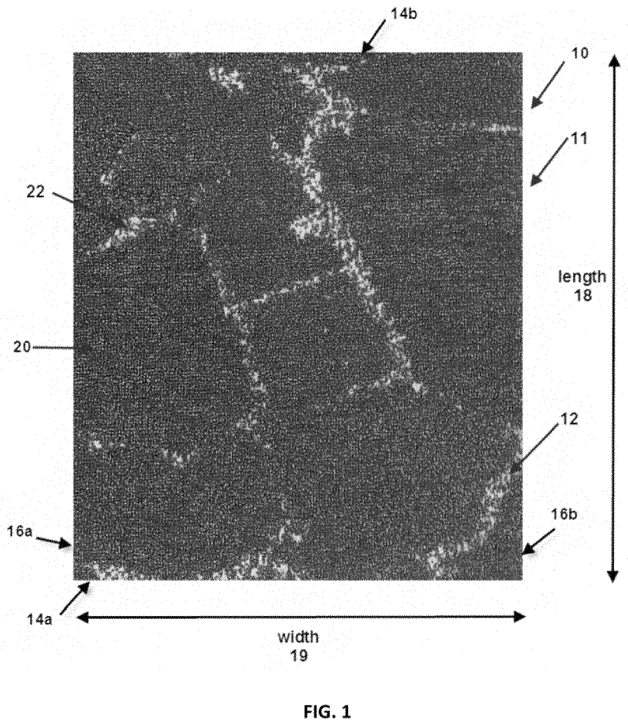

In one aspect, and as shown in FIG. 1, a carpet tile 11 is provided having first and second end edges 14a. 14b and first and second side edges 16a, 16b, In this aspect, it is contemplated that the distance between the first and second end edges 14a, 14b of the carpet tile 11 can correspond to a length 18 of the carpet tile. It is further contemplated that the distance between the first and second side edges 16a, 16b of the carpet tile 11 can correspond to a width 19 of the carpet tile.

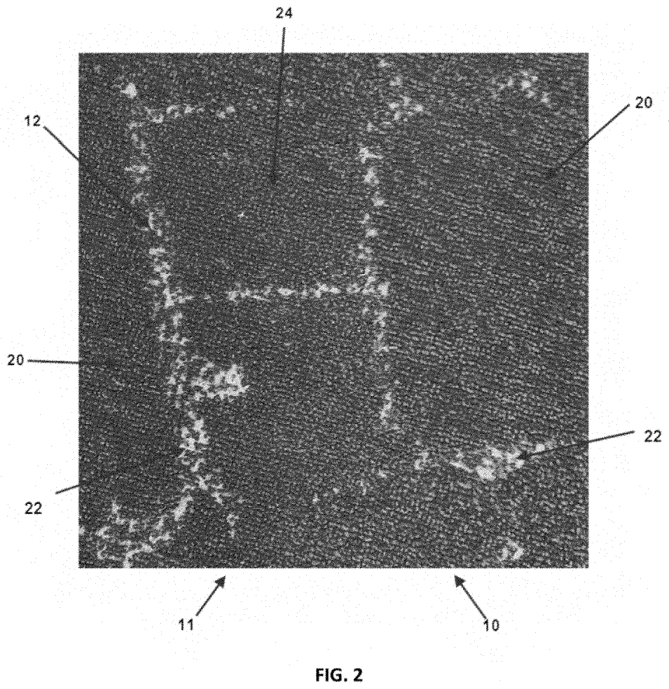

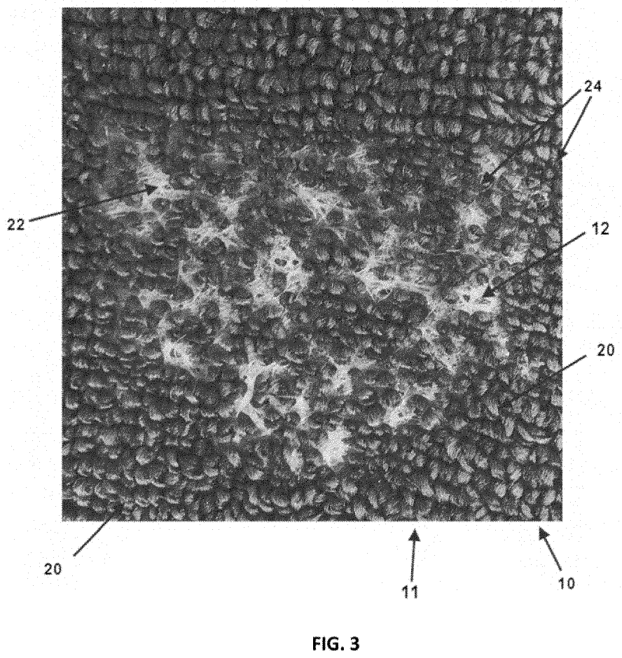

Referring now to the drawings, in which identical numbers indicate identical elements throughout the various views, FIGS. 1-3 illustrate a first aspect of a tufted carpet 10 having an at least partially visible primary backing 12, hereto referred to as deconstructed carpet 10. Conventionally, primary backing is considered only a structural element of carpet and visible primary backing in carpet is considered to be a defect. However, the present disclosure utilizes the primary backing layer as a design element of the overall pattern and styling in order to reduce material use, waste and the ounce weight of the finished carpet and to improve the method of carpet construction. In one example, in order to expose the primary backing 12, at least some yarn can be pulled very low in the exposed member pattern areas 22 to expose or otherwise make visible to an external viewer, desired amounts of the primary backing layer. It is contemplated that the primary backing layer can have a primary backing color that comprises part of the overall pattern and styling of the deconstructed carpet.

In aspects of the present disclosure, the deconstructed carpet can have the tufting pile heights adjusted over conventional tufted carpet such that a previous medium pile height becomes a low pile height and the previous low pile height becomes very low against the primary backing. It is contemplated that the deconstructed carpet can then be finished similarly to conventional tufted carpet. In light of the present disclosure, one skilled in the art will appreciate that lowering of the pile heights can allow for a reduction in tufted weight. Thus, in another aspect, the ounce weight of the deconstructed carpet can be from about 6 to about 25 oz., optionally, from about 8 to about 16 oz., and, more particularly, about 10 oz. in a patterned deconstructed carpet.

The deconstructed carpet shown in FIG. 1 can be formed by a conventional carpet tufting machine. For example, conventional tufting machine having a single bar of needles, two bars of needles, and the like can be used. The deconstructed carpet can be, but does not have to be, manufactured using a conventional carpet tufting machine. Among other alternatives, and not meant to be limiting, the deconstructed carpet may be produced on a carpet tufting machine havi2g ¼ gauge needle bars, ⅛ gauge needle bars, and/or 10 gauge needle bars. In one exemplary aspect, the desired carpet pattern design (and full and partial repeats thereof, if desired) comprising the one or more tufted portion pattern members 20 and the one or more exposed pattern members 22 can be formed on the deconstructed carpet by controlling the height of the yarn tufts and the “thread-up”of the machine, i.e., the arrangement of yarn colors dedicated to the needles of the tufting machine.

Each needle can be threaded with a dedicated yarn type (e.g., single color, space dyed, barber pole, etc.) and color(s). In one example, the color shapes of the tufted portion pattern members are formed on the color web by contrast between adjacent yarn colors on a single needle row and by contrast between the yarn colors on the needle bar or needle bars. Thus, the types and colors of yarn 24 used should be selected to achieve a desired contrast between areas of the desired pattern design of the carpet. For example, at least one color in the one or more tufted portion pattern members should be used to achieve the desired color contrast against the colored primary backing. However, it is optional, but not necessary, to use more than one color to achieve the desired color contrast. For example, the primary backing color should differ from the color therein the tufted portion pattern members in either one of, or a combination of, hue, chrome, and/or value. In one exemplary aspect, the primary backing color differs from the plurality of yarns that form the at least one color in the tufted portion pattern members.

Any thread-up of the machine may be used in accordance with this invention so long as the resultant web forms a carpet in accord with the directed color and texture design of the deconstructed carpet. In aspects, deconstructed carpet allows a singular color yarn to be used and the exposure of the primary backing creates the desired pattern design of the carpet by the color contrast between the color of the yarn and the color of the primary backing. It is also contemplated that multiple colored yarns can be used; however, one skilled in the art will appreciate that in a deconstructed carpet, multiple colored yarns are no longer a requirement to provide pattern.

As noted above, the characteristic of the deconstructed carpet 10 can be further controlled by varying the height of the yarn, i.e., controlling the pile height of the deconstructed carpet. The longer the length of yarn that is pushed through the primary backing, the greater its height in the finished carpet. In the exemplary deconstructed carpet, at least some primary backing can be visible in some portions of the tufted portion pattern members, and some areas can show substantially only primary backing.

In other aspects, either broadloom carpet or carpet tiles can be manufactured using the deconstructed carpet. In exemplary aspects, the carpet tile 11 can be substantially rectangular (having a length 18 and a width 19 that are substantially different). It is also contemplated that the carpet tile 11 can be substantially square (having a length 18 and a width 20 that are substantially equal). However, it is contemplated that the carpet tile 11 can have any desired shape, including a desired conventional shape or a desired irregular and/or organic shape. In further exemplary aspects, it is contemplated that the carpet tile 11 can have a tufted face, a woven face, or a fusion-bonded face that is formed according to conventional methods. In an additional exemplary aspect, it is contemplated that at least a portion of the face of the carpet tile 11 can be printed using conventional methods.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is therefore understood that the invention is not limited to the specific embodiments disclosed herein, and that many modifications and other embodiments of the invention are intended to be included within the scope of the invention. Moreover, although specific terms are employed herein, they are used only in a generic and descriptive sense, and not for the purposes of limiting the described invention.

What is claimed is:

1. A carpet the comprising:
a primary backing layer having a top surface and an opposing bottom surface, the primary backing layer having a primary backing color;
a plurality of yarn tufts extending upwardly from at least a portion of the top surface of the primary backing layer, wherein each yarn tuft of the plurality of yarn tufts has a pile height and a contrast color that is different than the primary backing color;
an adhesive backing material secured to the bottom surface of the primary backing layer; and
a secondary backing material secured to the adhesive backing material,
wherein the primary backing layer and the plurality of yarn tufts cooperate to define a face pattern of the carpet, wherein the face pattern comprises:
a first tufted section comprising yarn tufts of the plurality of yarn tufts that are pulled sufficiently low against the top surface of the primary backing layer to expose portions of the primary backing layer that surround the yarn tufts within the first tufted section;
a second tufted section comprising yarn tufts of the plurality of yarn tufts that have a pile height that is greater than the pile height of the yarn tufts of the first tufted section, wherein the yarn tufts of the second tufted section obscure portions of the primary backing layer that surround the yarn tufts within the second tufted section; and
a third section comprising only the primary backing layer.

2. The carpet tile of claim 1, wherein each yarn tuft of the plurality of yarn tufts has the same contrast color.

3. The carpet tile of claim 1, wherein the contrast color of at least one yarn tuft of the plurality of yarn tufts is different than the contrast color of at least one other yarn tuft of the plurality of yarn tufts.

4. The carpet tile of claim 2, wherein the contrast color differs from the primary backing color in at least one of hue, chrome, or value.

5. The carpet tile of claim 3, wherein the contrast color of each yarn tuft of the plurality of yarn tufts differs from the primary backing color in at least one of hue, chroma, or value.

6. The carpet tile of claim 1, wherein the pile height of the yarn tufts of the second tufted section varies within the second tufted section.

7. The carpet tile of claim 1, wherein the carpet tile has an ounce weight ranging from 6 to 25 oz. per square yard.

8. The carpet tile of claim 1, wherein the carpet tile has an ounce weight ranging from 8 to 16 oz. per square yard.

9. The carpet tile of claim 1, wherein the carpet tile has an ounce weight of about 10 oz. per square yard.

10. The carpet tile of claim 1, wherein the primary backing layer comprises a woven material.

11. A method comprising:
tufting a plurality of yarn tufts through a primary backing layer, the primary backing layer having a top surface and an opposing bottom surface, the primary backing layer having a primary backing color, wherein the plurality of yarn tufts extend upwardly from at least a portion of the top surface of the primary backing layer, wherein each yarn tuft of the plurality of yarn tufts has a pile height and a contrast color that is different than the primary backing color, wherein the primary backing layer and the plurality of yarn tufts cooperate to define a face pattern of the carpet;
securing an adhesive backing material to the bottom surface of the primary backing layer; and
securing a secondary backing material to the adhesive backing material,
wherein tufting the plurality of yarn tufts further comprises pulling yarn tufts of the plurality of yarn tufts sufficiently low against the top surface of the primary backing layer to expose portions of the primary backing layer that surround the yarn tufts within a first tufted section of the face pattern,
wherein the face pattern further comprises:
a second tufted section comprising yarn tufts of the plurality of yarn tufts that have a pile height that is greater than the pile height of the yarn tufts of the first tufted section, wherein the yarn tufts of the second tufted section obscure portions of the primary backing layer that surround the yarn tufts within the second tufted section; and
a third section comprising only the primary backing layer.

12. The method of claim 11, wherein each yarn tuft of the plurality of yarn tufts has the same contrast color.

13. The method of claim 11, wherein the contrast color of at least one yarn tuft the plurality of yarn tufts is different than the contrast color of at least one other yarn tuft of the plurality of yarn tufts.

14. The method of claim 12, wherein the contrast color differs from the primary backing color in at least one of hue, chroma, or value.

15. The method of claim 13, wherein the contrast color of each yarn tuft of the plurality of yarn tufts differs from the primary backing color in at least one of hue, chroma, or value.

16. The method of claim 11, wherein the pile height of the yarn tufts of the second tufted section varies within the second tufted section.

17. The method of claim 11, wherein the carpet tile has an ounce weight ranging from 6 to 25 oz. per square yard.

18. The method of claim 1, wherein the carpet tile has an ounce weight ranging from 8 to 16 oz. per square yard.

19. The method of claim 11, wherein the carpet tile has an ounce weight of about 10 oz. per square yard.

20. The method of claim 11, wherein the primary backing layer comprises a woven material.
